(19) United States
(12) Patent Application Publication
(10) Pub. No.: US 2008/0186159 A1
(43) Pub. Date: Aug. 7, 2008

(54) Enabling Vision Systems in Automobiles

(75) Inventors: Robert B. Powers, Ortonville, MI (US); Kent S. Lybecker, St. Clair Shores, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/671,064

(22) Filed: Feb. 5, 2007

(51) Int. Cl. B60Q 1/00; G09F 9/00

(52) U.S. Cl. 340/461; 340/937

(57) ABSTRACT

An apparatus is provided for a system, including a sensing module, a camera, and a display, for providing video images taken from a rear section of a vehicle to a driver. The sensing module is configured to sense at least one of when the driver is preparing to enter the vehicle and when the driver has entered the vehicle. The camera is disposed near the rear section of the vehicle. The camera is coupled to receive a camera actuation signal when the sensor senses that the driver is preparing to enter or has entered the vehicle, and is configured, upon receipt thereof, to capture video images behind the vehicle. The display is coupled to receive a display actuation signal, and is configured, upon receipt thereof, to receive the video images from the camera and to display the images.

### TECHNICAL FIELD

The present invention generally relates to an enabling vision system in vehicles, and more particularly relates to an enabling vision system in vehicles featuring a camera disposed near a rear section of the vehicle.

### BACKGROUND OF THE INVENTION

Vehicles generally have rear view mirrors and side mirrors to help drivers view objects and conditions behind the vehicle. In addition, some vehicles have a rear camera to provide video images from behind the vehicle for the driver, thereby further improving visibility behind the vehicle, for example when backing up. Generally, such rear cameras are activated once the vehicle is put in reverse. However, it may be preferable at times to have a rear camera activated before the vehicle is put in reverse, to provide the driver with additional time to view the video images from behind the vehicle.

Accordingly, it is desirable for a rear vision system that is activated before the vehicle is put in reverse. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An apparatus is provided for a system for providing video images taken from a rear section of a vehicle to a driver. In one embodiment, and by way of example only, the system comprises a sensing module, a camera, and a display. The sensing module is configured to sense at least when the driver is preparing to enter the vehicle. The camera is disposed near the rear section of the vehicle. The camera is coupled to receive a camera actuation signal when the sensor senses that the driver is preparing to enter the vehicle, and is configured, upon receipt thereof, to capture video images behind the vehicle. The display is coupled to receive a display actuation signal, and is configured, upon receipt thereof, to receive the video images from the camera and to display the images.

In another embodiment, and by way of example only, the system comprises a sensing module, a camera, and a display. The sensing module is configured to sense at least when the driver has entered the vehicle. The camera is disposed near the rear section of the vehicle. The camera is coupled to receive a camera actuation signal when the sensing module has detected that the driver has entered the vehicle, and is configured, upon receipt thereof, to capture video images behind the vehicle. The display is coupled to receive a display actuation signal, and is configured, upon receipt thereof, to receive the video images from the camera and to display the images.

In yet another embodiment, and by way of example only, the system comprises a sensing module, a camera, a display, a power delivery mechanism, a communication bus, and a video delivery module. The sensing module is configured to sense at least when the driver is preparing to enter the vehicle. The camera is disposed near the rear section of the vehicle. The camera is coupled to receive a camera actuation signal when the sensor senses that the driver is preparing to enter the vehicle, and is configured, upon receipt thereof, to capture video images behind the vehicle. The display is coupled to receive a display actuation signal, and is configured, upon receipt thereof, to receive the video images from the camera and to display the images. The power delivery mechanism is configured to receive a power actuating signal and is configured, upon receipt thereof, to provide the camera actuation signal to the camera. The communication bus is coupled to the sensing module and the power delivery mechanism, and is configured to communicate the power actuation signal to the power delivery mechanism when the sensing module senses that the driver has entered the vehicle. The video delivery module is coupled to the camera and the display, and is configured to deliver the video images from the camera to the display.

### DESCRIPTION OF THE DRAWINGS

The present invention will hereinafter be described in conjunction with the following drawing figures, wherein like numerals denote like elements, and

FIG. 1 depicts a side view of a vehicle with a rear vision system; and

FIG. 2 depicts a schematic representation of a rear vision system for use in a vehicle.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

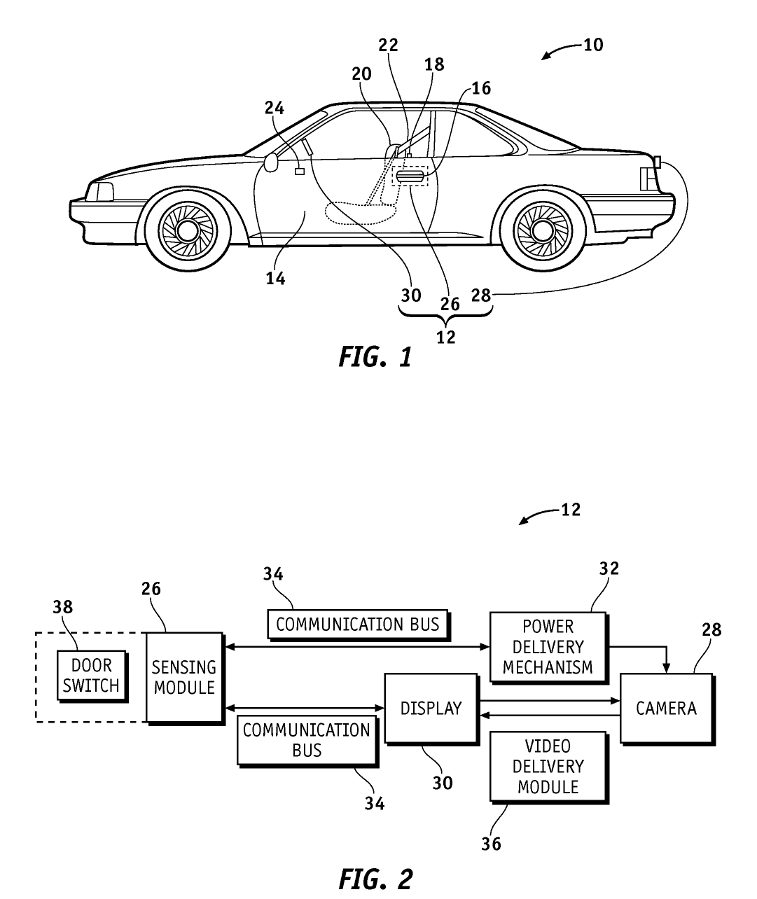

FIG. 1 depicts a vehicle 10 with a rear vision system 12. The vehicle 10 may be an automobile, a sport utility vehicle, a recreational vehicle, a van, a truck, or any one of a number of different types of vehicles. As depicted in FIG. 1, the vehicle 10 also includes a driver's side door 14 with a handle 16 and a lock 18, a driver's seat 20 with a seat belt 22, and an ignition 24 for insertion of keys by the driver.

The rear vision system 12 is configured to provide video images taken from behind the vehicle 10 to a driver, and, as shown in FIGS. 1-2, includes at least a sensing module 26, a camera 28, and a display 30. The rear vision system 12 can also include a power delivery mechanism 32, a communication bus 34, and a video delivery module 36, as shown in FIG. 2.

The sensing module 26, shown in phantom in FIG. 1 and also shown in the schematic representation in FIG. 2, is configured in one embodiment to sense at least when the driver is preparing to enter the vehicle 10. In a most preferred embodiment, the sensing module 26 includes or is coupled to a switch 38, shown in FIG. 2, that is configured to sense when the driver's side door 14 has been opened. Alternatively, the sensing module 26 can be configured to sense when the driver has touched the driver's side door handle 16, and/or when the driver's side door 14 has been unlocked, for example manually or via a remote device, and/or any one of a number of other different signals for when the driver is about to enter the vehicle 10.

Alternatively, the sensing module 26 can be configured to sense when the driver has entered the vehicle 10. For example, in such embodiment(s), the sensing module 26 can be configured to sense when the driver has sat down in the driver's seat 20, and/or when the driver has buckled up the seat belt 22 for the driver's seat 20, and/or when a key has been placed in the ignition 24, and/or any one of a number of other different signals for when the driver has entered the vehicle 10. However, regardless of its particular configuration, the sensing module 26 provides an actuation signal once the driver is about to enter, or has entered, the vehicle 10.

The camera 28 is coupled to receive a camera actuation signal when the sensing module 26 senses that the driver is preparing to enter the vehicle, and is configured, upon receipt thereof, to capture video images behind the vehicle 10. As depicted in FIG. 1, the camera 28 is preferably disposed near a rear section of the vehicle 10, so as to facilitate capturing video images behind the vehicle 10. However, it will be appreciated that the camera 28 may also be disposed in any one of a number of different parts of the vehicle, such that the camera 28 is facing toward the rear section of the vehicle 10 with an unobstructed view of objects or conditions behind the vehicle 10.

The camera 28 can be any one of a number of different types of cameras capable of capturing video images including, by way of example only, an analog camera, a digital camera, or various other types of cameras. However, regardless of the type of camera 28, and its position on the vehicle 10, the camera 28 is configured to capture video images behind the vehicle 10, so that these images can be viewed by the driver.

The display 30 is coupled to receive a display actuation signal, and is configured, upon receipt thereof, to receive the video images from the camera 28 and to display the video images for the driver. Preferably, the display 30 receives the display actuation signal at or about the same time that the camera 28 receives the camera actuation signal. In a most preferred embodiment described further below, the display 30 receives the display actuation signal when the sensing module 26 senses that the driver is preparing to enter or has entered the vehicle 10, and, upon receipt of the display actuation signal, provides the camera actuation signal to the camera 28, for example by supplying power to the camera 28. However, it will be appreciated that the display actuation signal and the camera actuation signal can be received simultaneously or in any order, and that each can be transmitted via any one of a number of different mechanisms.

The display 30 can display the video images for the driver in any one of a number of different places in the vehicle 10. For example, the display 30 can be disposed on or within the dash board or rear view mirror, among various other possible locations for the display 30. The display 30 can be in the same module as another feature of the rear vision assembly 12, such as the sensing module 26, or can be in a separate module. However, regardless of its particular location and configuration, the display 30 displays the video images from the camera 28 for viewing by the driver.

As mentioned above and depicted in FIG. 2, the rear vision system 12 may also include a power delivery mechanism 32, a communication bus 34, and/or a video delivery module 36.

The power delivery mechanism 32 is configured to receive a power actuating signal, preferably from the communication bus 34, and preferably when the sensing module 26 senses that the driver is preparing to enter, or has entered, the vehicle 10. In a preferred embodiment, the power delivery mechanism 32 provides power to the camera 28 upon receiving the power actuation signal.

In a most preferred embodiment, the display 30 is the power delivery mechanism 32, and the power actuation signal is the same as, or communicated along with, the display actuation signal. In this most preferred embodiment, the display 30 receives the display actuation signal/power actuation signal, preferably from the communication bus 34, when the sensing module 26 senses that the driver is preparing to enter or has entered the vehicle 10. Upon receiving the display actuation signal/power actuation signal, the display 30 provides power to actuate the camera 28. However, it will be appreciated that in other embodiments the power delivery mechanism 32 can be different from the display 30, and/or that such a different power delivery mechanism 32 can be used in conjunction with or separately from the display 30, and/or that any one of a number of different types of mechanisms can be used to transmit any one of a number of different types of camera actuation signals to the camera 28.

The communication bus 34 is coupled to the sensing module 26 and the power delivery mechanism 32, and is configured to communicate the power actuation signal to the power delivery mechanism 32 when the sensing module 26 senses that the driver is preparing to enter or has entered the vehicle 10. By way of example only, the communication bus 34 may deliver the power actuation signal via connections provided over any type of serial, parallel, wireless or other data communication medium, among various other types of mechanisms of communication.

The video delivery module 36 is coupled to the camera 28 and the display 30, and is configured to deliver the video images from the camera 28 to the display 30. The video delivery module 36 may be configured to send the video images to the display via composite video, digital video, or fiber optic connections, or any one of a number of other different mechanisms for delivery of the video images from the camera 28 to the display 30.

The operation of the rear vision system 12, in a preferred embodiment, is as follows. As the driver is preparing to enter or enters the vehicle 10 (for example, when the driver opens the driver's side door 14), this is sensed by the switch 38 of the sensing module 26. The display 30 then receives the display actuation signal via the communication bus 34 and, upon receipt thereof, provides power to the camera 28. Next, the camera 28 takes video images from behind the vehicle 10, and sends the video images to the display 30 via the video delivery module 36. The display 30 then receives the video images, and displays the video images for the driver.

As mentioned above, it will be appreciated that other methods of operation may be used, for example with a different power delivery mechanism 32, and/or any one of a number of different types of mechanisms for transmitting any one of a number of different types of camera actuation signals to the camera 28. It will similarly be appreciated that various features of the rear vision system 12 may take different configurations, may operate within a single module, and/or may be divided into various sub-modules in other embodiments.

The rear vision system 12 allows the driver to view objects and conditions behind the vehicle 10 for a longer period of time as the driver enters the vehicle 10, and/or as the driver prepares to begin driving. For example, the rear vision system 12 allows the driver to view the objects and conditions behind the vehicle 10 while the driver is adjusting the driver's seat or the rear view mirror, thereby further improving the driver's visibility behind the vehicle 10 for a longer period of time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system for providing video images taken from a rear section of a vehicle to a driver, the system comprising:
a sensing module configured to sense at least when the driver is preparing to enter the vehicle;
a camera disposed near the rear section of the vehicle, the camera coupled to receive a camera actuation signal when the sensing module senses that the driver is preparing to enter the vehicle, and configured, upon receipt thereof, to capture video images behind the vehicle; and
a display coupled to receive a display actuation signal and configured, upon receipt thereof, to receive the video images from the camera and to display the images.

2. The system of claim 1, further comprising:
a power delivery mechanism configured to receive a power actuating signal and configured, upon receipt thereof, to provide the camera actuation signal to the camera; and
a communication bus coupled to the sensing module and the power delivery mechanism and configured to communicate the power actuation signal to the power delivery mechanism when the sensing module senses that the driver is preparing to enter the vehicle.

3. The system of claim 2, wherein the display is the power delivery mechanism.

4. The system of claim 1, further comprising:
a video delivery module coupled to the camera and the display and configured to deliver the video images from the camera to the display.

5. The system of claim 1, wherein the vehicle comprises a driver's side door, and wherein the sensing module is configured to sense when the driver's side door has been opened.

6. The system of claim 1, wherein the vehicle comprises a driver's side door with a handle, and wherein the sensing module is configured to sense when the driver has touched the driver's side door handle.

7. The system of claim 1, wherein the vehicle comprises a driver's side door, and wherein the sensing module is configured to sense when the driver's side door has been unlocked.

8. The system of claim 7, wherein the sensing module is configured to sense when the driver's side door is unlocked via a remote device.

9. The system of claim 7, wherein the sensing module is configured to sense when the driver's side door is manually unlocked.

10. A system for providing video images taken from a rear section of a vehicle to a driver, the system comprising:
a sensing module configured to sense at least when the driver has entered the vehicle;
a camera disposed near the rear section of the vehicle, the camera coupled to receive a camera actuation signal when the sensing module senses that the driver has entered the vehicle, and configured, upon receipt thereof, to capture video images behind the vehicle; and
a display coupled to receive a display actuation signal and configured, upon receipt thereof, to receive the video images from the camera and to display the images.

11. The system of claim 10, further comprising:
a power delivery mechanism configured to receive a power actuating signal and configured, upon receipt thereof, to provide the camera actuation signal to the camera; and
a communication bus coupled to the sensing module and the power delivery mechanism and configured to communicate the power actuation signal to the power delivery mechanism when the sensing module senses that the driver has entered the vehicle.

12. The system of claim 11, wherein the display is the power delivery mechanism.

13. The system of claim 10, further comprising:
a video delivery module coupled to the camera and the display and configured to deliver the video images from the camera to the display.

14. The system of claim 10, wherein the vehicle has a driver's seat, and wherein the sensing module is configured to sense when the driver has sat down in the driver seat.

15. The system of claim 10, wherein the vehicle has an ignition for a key to operate the vehicle, and wherein the sensing module is configured to sense when the key is placed in the ignition.

16. The system of claim 10, wherein the vehicle has a driver's seat belt, and wherein the sensing module is configured to sense when the driver has buckled the driver's seat belt

17. A system for providing video images taken from a rear section of a vehicle to a driver, the system comprising:
a sensing module configured to sense at least when the driver is preparing to enter the vehicle;
a camera disposed near the rear section of the vehicle, the camera coupled to receive a camera actuation signal when the sensing module senses that the driver is preparing to enter the vehicle and configured, upon receipt thereof, to capture video images behind the vehicle; and
a display coupled to receive a display actuation signal and configured, upon receipt thereof, to receive the video images from the camera and to display the images;
a power delivery mechanism configured to receive a power actuating signal and configured, upon receipt thereof, to provide the camera actuation signal to the camera;
a communication bus coupled to the sensing module and the power delivery mechanism and configured to communicate the power actuation signal to the power delivery mechanism when the sensing module senses that the driver is preparing to enter the vehicle; and
a video delivery module coupled to the camera and the display and configured to deliver the video images from the camera to the display.

18. The system of claim 17, wherein the display is the power delivery mechanism.

19. The system of claim 17, wherein the vehicle comprises a driver's side door, and wherein the sensing module is configured to sense when the driver's side door has been opened.

20. The system of claim 17, wherein the vehicle comprises a driver's side door with a handle, and wherein the sensing module is configured to sense when the driver has touched the driver's side door handle.
